(19) United States
(12) Patent Application Publication
(10) Pub. No.: US 2026/0264914 A1
(43) Pub. Date: Sep. 10, 2026

(54) METHOD AND SYSTEM FOR AUTOMATING CUSHIONING MATERIAL FILLING AND PACKAGING BASED ON 3D SPACE DETECTION DATA

(71) Applicant: YUNHUNPLUS CO,.LTD, Hwaseong-si, Gyeonggi-do (KR)

(72) Inventor: Young In HAN, Yongin-si, Gyeonggi-do (KR)

(73) Assignee: YUNHUNPLUS CO,.LTD, Hwaseong-si, Gyeonggi-do (KR)

(21) Appl. No.: 19/473,777

(22) PCT Filed: Jan. 26, 2024
(86) PCT No.: PCT/KR2024/001291

§ 371 Date: Oct. 8, 2025

(30) Foreign Application Priority Data
Apr. 12, 2023 (KR) 10-2023-0048455

(51) Int. Cl. B65B 61/22; B65B 57/04

(52) U.S. Cl. CPC B65B 61/22; B65B 57/04; B65B 2210/04

(57) ABSTRACT

The present invention relates to a method and system for automating cushioning material filling and packaging based on 3D space detection data. A system according to the present invention comprises: a three-dimensional scanner installed at a predetermined distance above a conveyor belt to three-dimensionally scan, in a downward direction from above a packaging box, the interior of the packaging box being conveyed on the conveyor belt in a state in which an upper surface of the packaging box is open; a robot that performs an operation of loading cushioning material into an internal empty space region of the packaging box excluding an object contained in the packaging box; and a computing device that processes three-dimensional scanning data acquired from the three-dimensional scanner to detect the internal empty space region of the packaging box, calculates, for each combination of a cushioning material stacking direction, a type of cushioning material, and a cushioning material loading path pattern, a cushioning material loading path for loading the cushioning material into the internal empty space region, selects, among the combinations, a combination in which a difference between a volume of the cushioning material loaded according to the calculated cushioning material loading path and a volume of the internal empty space region is minimized, and generates a command code to operate the robot to load the cushioning material into the internal empty space region according to the cushioning material loading path of the selected combination.

### TECHNICAL FIELD

The present invention relates to a method and system for automating cushioning material filling and packaging using a robot.

### BACKGROUND ART

With the growth of the e-commerce market, logistics automation systems have been introduced in logistics centers. However, the packaging process of filling empty spaces in packaging boxes with cushioning material to protect products and completing the packaging still requires a significant amount of manual labor.

In order to solve this problem, packaging automation technology has been developed, as disclosed in Korean Registered U.S. Pat. No. 1,960,025 (registration date: Mar. 13, 2019). However, such technology has limitations in that it can only be applied to a single cushioning material, bubble wrap.

Accordingly, there is an increasing demand for a box packaging automation method and system using a robot, which can generate a cushioning material loading path optimized for the type of product and the shape of the empty space in the packaging box, select from among air cushions, foamed styrofoam, pulp mold, cardboard partitioned boxes, styrofoam boxes, and cushion paper, and automatically package boxes using an optimal amount of cushioning material along the generated path.

### DISCLOSURE

### Technical Problem

A technical objective of the present invention is to provide a method and system for automating cushioning material filling and packaging using a robot, in which an optimal amount of cushioning material is supplied into an irregular internal empty space region of a packaging box based on 3D space detection data.

### Technical Solution

In order to achieve the above technical objective, a cushioning material filling and packaging automation system using a robot according to the present invention comprises: a three-dimensional scanner installed at a predetermined distance above a conveyor belt to three-dimensionally scan, in a downward direction from above a packaging box, the interior of the packaging box being conveyed on the conveyor belt in a state in which an upper surface of the packaging box is open; a robot that performs an operation of loading cushioning material into an internal empty space region of the packaging box excluding an object contained therein; and a computing device that processes three-dimensional scanning data acquired from the three-dimensional scanner to detect the internal empty space region of the packaging box, calculates, for each combination of a cushioning material stacking direction, a type of cushioning material, and a cushioning material loading path pattern, a cushioning material loading path for loading the cushioning material into the internal empty space region, selects, among the combinations, a combination in which a difference between a volume of the cushioning material loaded according to the calculated cushioning material loading path and a volume of the internal empty space region is minimized, and generates a command code to operate the robot to load the cushioning material into the internal empty space region according to the selected cushioning material loading path.

The robot may be capable of selecting and replacing an end effector corresponding to a type of cushioning material.

The cushioning material stacking direction may include a third direction perpendicular to a plane formed by a first direction and a second direction.

A direction in which variance of packaging box empty-space modeling data corresponding to the internal empty space region is greatest may be the first direction, and a direction in which the variance of the packaging box empty-space modeling data is second greatest may be the second direction.

The cushioning material stacking direction may further include at least one of a horizontal direction parallel to a bottom surface of the packaging box and a vertical direction perpendicular to the bottom surface of the packaging box.

The computing device may divide the internal empty space region into a plurality of individual stacking planes having a predetermined thickness in accordance with the cushioning material loading direction, and may calculate a cushioning material stacking path for loading cushioning material into each of the plurality of individual stacking planes according to a cushioning material loading path pattern.

The computing device may terminate the cushioning material loading operation of the robot for the packaging box if, while the robot is performing the operation of loading cushioning material into the internal empty space region according to the command code, a filling rate of the cushioning material filled in the internal empty space region is greater than or equal to a predetermined reference.

In order to achieve the above technical objective, a cushioning material filling and packaging automation method using a robot according to the present invention comprises: three-dimensionally scanning, using a three-dimensional scanner installed at a predetermined distance above a conveyor belt, in a downward direction from above a packaging box being conveyed on the conveyor belt in a state in which an upper surface of the packaging box is open; processing three-dimensional scanning data acquired from the three-dimensional scanner to detect an internal empty space region of the packaging box excluding an object contained therein; calculating, for each combination of a cushioning material stacking direction, a type of cushioning material, and a cushioning material loading path pattern, a cushioning material loading path for loading cushioning material into the internal empty space region; selecting, among the combinations, a combination in which a difference between a volume of the cushioning material loaded according to the calculated cushioning material loading path and a volume of the internal empty space region is minimized; generating, according to the selected combination of the cushioning material stacking direction, the type of cushioning material, and the cushioning material loading path, a command code to operate a robot to load cushioning material into the internal empty space region; and performing, by the robot, an operation of loading cushioning material into the internal empty space region according to the command code.

The method may further comprise terminating the cushioning material loading operation of the robot for the packaging box if, while the robot is performing the operation of loading cushioning material into the internal empty space region according to the command code, a filling rate of the cushioning material filled in the internal empty space region is greater than or equal to a predetermined reference.

### [Effect]

According to the present invention, an optimal amount of cushioning material can be supplied in accordance with an empty space region of a packaging box. In addition, by selecting a cushioning material stacking direction in accordance with the empty space region of the packaging box, the cushioning material can be stably loaded. Furthermore, a cushioning material loading path pattern, by which the cushioning material can be loaded in a manner similar to the empty space region of the packaging box, can be selected in consideration of characteristics of the cushioning material.

### DESCRIPTION OF DRAWINGS

FIG. 1 is a conceptual diagram of an operation of a cushioning material filling and packaging automation system using a robot according to an embodiment of the present invention.

FIG. 2 is a block diagram of a cushioning material filling and packaging automation system using a robot according to an embodiment of the present invention.

FIG. 3 is a diagram illustrating an example of an air cushioning material.

FIG. 4 is a flowchart for explaining an operation of a cushioning material filling and packaging automation system using a robot according to an embodiment of the present invention.

FIG. 5 is a diagram illustrating an example of a combination for calculating a cushioning material loading path according to an embodiment of the present invention.

FIG. 6 is a diagram for explaining a process of dividing a cushioning material loading path to generate a command code for a cushioning material loading operation of a robot according to the present invention.

### BEST MODE

Hereinafter, embodiments of the present invention will be described in detail with reference to the accompanying drawings so that those skilled in the art to which the present invention pertains can easily implement the present invention.

The terms used in this specification are intended to describe embodiments only and are not intended to limit the present invention. In this specification, a singular expression also includes a plural expression unless specifically stated otherwise in the context. The terms “comprises” and/or “comprising,” as used in this specification, do not preclude the presence or addition of one or more other components in addition to the stated components. Throughout this specification, the same reference numerals refer to the same components, and “and/or” includes each and combinations of one or more of the specified components. Although the terms “first,” “second,” and the like are used to describe various components, such components are not limited by these terms. These terms are used only to distinguish one component from another. Therefore, it should be understood that a first component referred to below may also be a second component within the technical scope of the present invention.

As used in this specification, the term “computing device” includes all kinds of devices capable of performing computational processing to provide results to a user. For example, the computing device may include not only a desktop PC, a notebook computer, and a server computer, but also a smartphone, a tablet PC, a cellular phone, a PCS phone (Personal Communication Service phone), a synchronous/asynchronous IMT-2000 (International Mobile Telecommunication-2000) mobile terminal, a Palm PC (Palm Personal Computer), and a personal digital assistant (PDA).

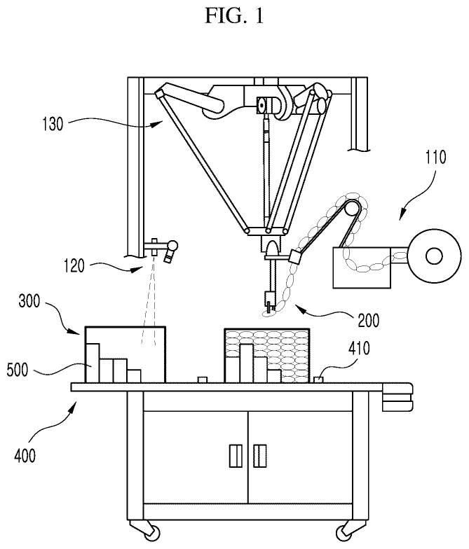

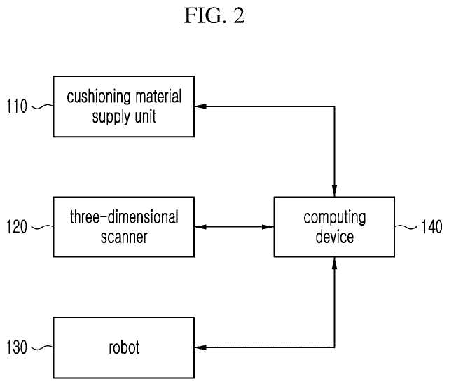

FIG. 1 is a conceptual diagram of an operation of a cushioning material filling and packaging automation system using a robot according to an embodiment of the present invention, and FIG. 2 is a block diagram of a cushioning material filling and packaging automation system using a robot according to an embodiment of the present invention.

Referring to FIGS. 1 and 2, a cushioning material filling and packaging automation system using a robot according to an embodiment of the present invention includes a cushioning material supply unit 110, a three-dimensional scanner 120, a robot 130, and a computing device 140.

A cushioning material supply unit 110 may supply a cushioning material 200 to a robot 130. The cushioning material supply unit 110 may supply, under control of a computing device 140, a predetermined type of cushioning material to the robot 130. The types of cushioning material may include air cushioning material, foamed styrofoam, pulp mold, cardboard partitioned boxes, styrofoam boxes, and cushion paper, and in addition to these examples, various other types of cushioning material may also be used.

The cushioning material supply unit 110 may be implemented to selectively supply, under control of the computing device 140, a predetermined type of cushioning material among pre-manufactured cushioning materials to the robot 130, or may be implemented to form, in real time, a predetermined type of cushioning material into a predetermined shape under control of the computing device 140 and supply the same to the robot 130.

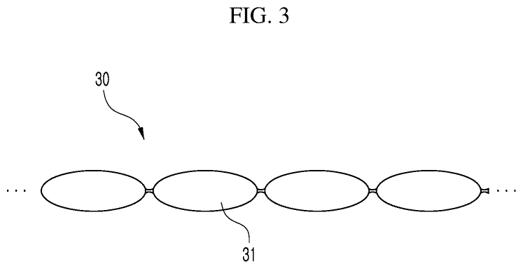

FIG. 3 is a diagram illustrating an example of an air cushioning material.

Referring to FIG. 3, an air cushioning material 30 may have a form in which air cells 31, which are the minimum unit of the cushioning material, are continuously connected, as illustrated in FIG. 3. As described above, the cushioning material supply unit 110 may be implemented as a device for manufacturing the air cushioning material such that the air cells 31 have a predetermined rigidity, length, and width. Of course, the cushioning material may also be in the form of individual units having a predetermined size and shape. For example, the cushioning material may be in the form of styrofoam balls. Information on the rigidity, length, and width of the minimum unit of the cushioning material may be stored in advance in the computing device 140.

A three-dimensional scanner 120 may be installed at a predetermined distance above a conveyor belt 400 so as to three-dimensionally scan, in a downward direction from above a packaging box 300, the interior of the packaging box 300 being conveyed on the conveyor belt 400 in a state in which its upper surface is open. The three-dimensional scanner 120 may use a laser 3D scanner, but is not limited thereto, and may also use a stereo camera, as long as three-dimensional scanning data of the internal empty space region of the packaging box 300 can be acquired.

When a packaging box 300 being conveyed on a conveyor belt 400 is detected by a stopper 410, the conveyor belt 400 is stopped, and a robot 130 performs an operation of loading a cushioning material 200 into an internal empty space region of the packaging box excluding an object 500 contained in the packaging box 300.

The robot 130 is not limited in its type or form as long as it can perform an operation of filling a cushioning material into the internal empty space region of the packaging box 300, and may include not only a delta robot as illustrated in FIG. 1. The robot 130 may be equipped with an end effector suitable for loading, into the internal empty space region of the packaging box, a cushioning material corresponding to each type of cushioning material. The term “loading” herein may include not only an operation of placing the cushioning material one by one on a stacking plane according to a cushioning material loading path in the internal empty space region, but also, in the case of spherical cushioning material, an operation of spraying or dropping the cushioning material one by one according to the cushioning material loading path so that the cushioning material is stacked on the stacking plane.

A computing device 140 may process three-dimensional scanning data acquired from a three-dimensional scanner 120 to detect the internal empty space region of the packaging box 300. The computing device 140 may calculate, for each combination of a cushioning material stacking direction, a type of cushioning material, and a cushioning material loading path pattern, a cushioning material loading path for loading cushioning material into the internal empty space region, and may select, among the combinations, a combination in which a difference between a volume of the cushioning material loaded according to the calculated cushioning material loading path and a volume of the internal empty space region is minimized. The computing device 140 may then generate a command code to operate the robot to fill the cushioning material into the internal empty space region of the packaging box 300 according to the cushioning material loading path of the selected combination and transmit the command code to the robot 130.

Here, a cushioning material loading path pattern refers to a pattern of a path for loading a cushioning material onto an individual stacking plane, such as a spiral, zigzag, linear, circular, or tornado pattern. For example, in the case of a linear pattern, it refers to a pattern in which the cushioning material is loaded in a straight line in the +X direction on an XY stacking plane, then moved in the Y direction, and then loaded again in a straight line in the −X direction.

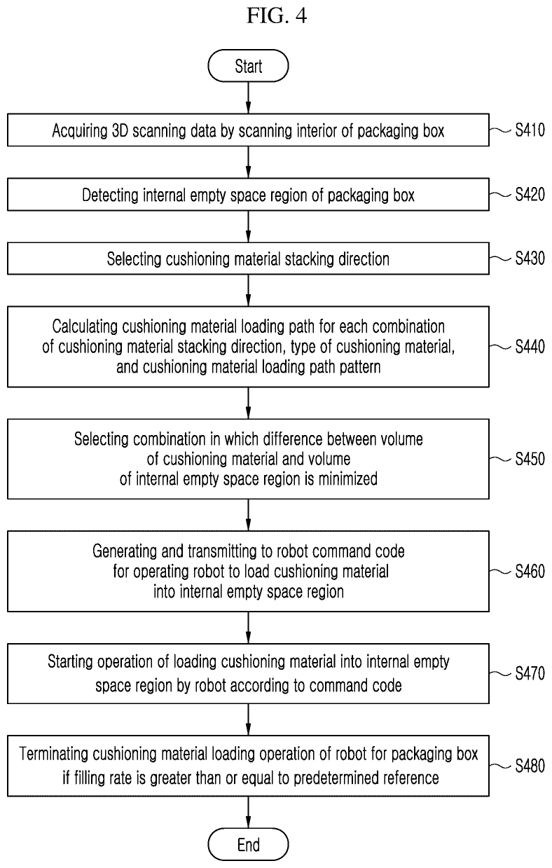

FIG. 4 is a flowchart for explaining an operation of a cushioning material filling and packaging automation system using a robot according to an embodiment of the present invention.

Referring to FIG. 4, three-dimensional scanning data may be acquired (S410) by three-dimensionally scanning, in a downward direction from above a packaging box 300, the interior of the packaging box 300 being conveyed on a conveyor belt 400 using a three-dimensional scanner 120.

Next, a computing device 140 may process three-dimensional scanning data acquired from the three-dimensional scanner 120 to detect an internal empty space region of the packaging box 300 excluding an object 500 contained therein (S420).

For example, three-dimensional scanning data acquired in step (S410) may include only point cloud data corresponding to surfaces of a packaging box and an object contained in the packaging box. Accordingly, a computing device 140 may first detect the packaging box and the object in the three-dimensional scanning data by using a machine learning model or a deep learning model trained to detect the packaging box and the object, and thereby inversely detect an internal empty space region of the packaging box. The computing device 140 may generate a packaging box empty-space model corresponding to the internal empty space region of the packaging box.

Next, the computing device 140 may select a cushioning material stacking direction (S430). Here, the cushioning material stacking direction refers to a direction in which stacking planes are layered from a lowest stacking plane to a highest stacking plane when the internal empty space region of the packaging box is divided into a plurality of individual stacking planes having a predetermined thickness. A robot 130 may be operated to sequentially load cushioning material onto each stacking plane from the lowest stacking plane to the highest stacking plane in the internal empty space region of the packaging box. The thickness of each individual stacking plane may be determined in consideration of the type of cushioning material.

More specifically, the cushioning material stacking direction may be selected so that when the robot 130 loads the cushioning material into the internal empty space region of the packaging box, the cushioning material loading time is shortened and the cushioning material can be stably loaded into the internal empty space region of the packaging box. In dynamics, a moment of inertia is used to measure a magnitude of torque required to rotate an object. By noting that the magnitude of the torque linearly depends on the moment of inertia, a PCA (Principal Component Analysis) algorithm may be used to determine the stacking direction.

For example, when a direction in which data variance of a packaging box empty-space model corresponding to an internal empty space region of the packaging box is greatest is defined as a first direction, and a direction in which the data variance of the packaging box empty-space model is second greatest is defined as a second direction, a cushioning material stacking direction may be selected as a third direction perpendicular to a plane formed by the first direction and the second direction.

However, depending on characteristics of the cushioning material according to its type, such as rigidity, length, and width, the previously selected cushioning material stacking direction may not be suitable. Accordingly, one or more of a horizontal direction parallel to a bottom surface of the packaging box 300 and a vertical direction perpendicular to the bottom surface of the packaging box 300 may additionally be selected as the cushioning material stacking direction.

Thereafter, a computing device 140 may calculate, for each combination of a cushioning material stacking direction, a type of cushioning material, and a cushioning material loading path pattern, a cushioning material loading path for loading the cushioning material into the internal empty space region of the packaging box (S440).

All types of cushioning material that can be supplied from a cushioning material supply unit 110 may be considered in step (S440). Of course, before step (S440), it is also possible to receive a selection of the type of cushioning material to be considered in step (S440) from a user. Alternatively, depending on a type of an object contained in the packaging box 300, the type of cushioning material to be considered in step (S440) may be selected.

Likewise, cushioning material loading path patterns prepared in advance, such as spiral, zigzag, linear, circular, and tornado patterns, may all be considered in step (S440). Of course, before step (S440), it is also possible to receive a selection of the cushioning material loading path pattern to be considered in step (S440) from a user. Alternatively, depending on a type of an object contained in the packaging box 300, the cushioning material loading path pattern to be considered in step (S440) may be selected.

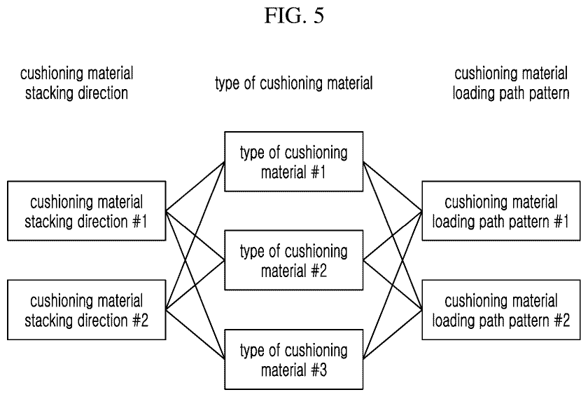

FIG. 5 is a diagram illustrating an example of a combination for calculating a cushioning material loading path according to an embodiment of the present invention.

Referring to FIG. 5, a computing device 140 may consider possible combinations of a cushioning material stacking direction, a type of cushioning material, and a cushioning material loading path pattern, divide an internal empty space region of a packaging box 300 into stacking planes having a predetermined thickness, and calculate a cushioning material loading path in consideration of rigidity, length, and width of a minimum unit of the cushioning material according to the type of cushioning material and the cushioning material loading path pattern of the corresponding combination.

Next, the computing device 140 may select, among the combinations of the cushioning material stacking direction, the type of cushioning material, and the cushioning material loading path pattern, a combination in which a difference between a volume (V_{F}) of the cushioning material loaded into the internal empty space region of the packaging box 300 according to the calculated cushioning material loading path and a volume (V_{S}) of the internal empty space region is minimized (S450).

$$R M S E = \sqrt{{( {V}_{F} - {V}_{S} )}^{2}} \qquad [ Equation 1 ]$$

The smaller the RMSE, the fewer the gaps in the internal empty space region, and it can be evaluated that the cushioning material is filled more similarly to the internal empty space region.

Thereafter, a computing device 140 may generate a command code to operate a robot 130 to load a cushioning material into the internal empty space region according to the cushioning material loading path of the combination selected in step (S450), and may transmit the command code to the robot 130 (S460).

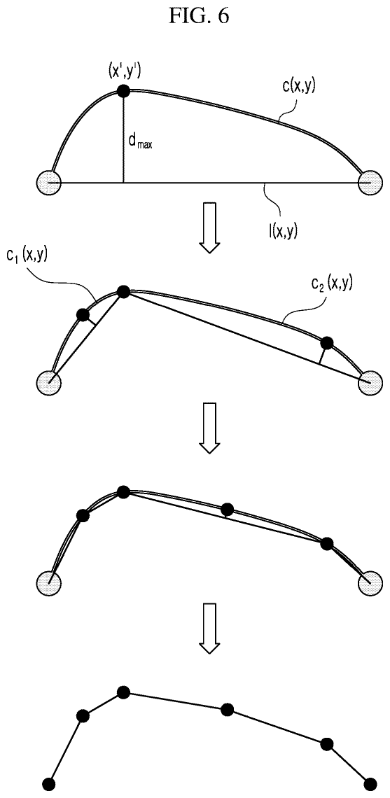

FIG. 6 is a diagram illustrating, by way of example, a process of generating a command code for operating a robot to load a cushioning material into an internal empty space region according to the present invention.

Referring to FIG. 6, it is assumed that a cushioning material loading path according to the combination selected in step (S450) is c(x, y), and the following process is performed.

Step 1: Create a straight line l(x, y) connecting a first point and a last point of c (x, y).

Step 2: Among points of c(x, y), find a point (x′, y′) located at a maximum distance (dmax) from the straight line l(x, y).

Step 3: When the maximum distance (dmax) is greater than a threshold, divide c(x, y) into c1(x, y) and c2(x, y) with the point (x′, y′) as a division point.

Step 4: Repeat steps 1 through 3 for c1(x, y) and c2(x, y) divided from c(x, y).

Steps 1 through 3 are repeated until the cushioning material loading path can no longer be divided, and all division points of the cushioning material loading path are obtained as shown at the bottom of FIG. 6. Then, using coordinates of the obtained division points, a command code may be generated to operate a robot to load a cushioning material into the internal empty space region.

Considering a case where the robot 130 is implemented as a delta robot, the delta robot is a motor-driven robot capable of three-dimensional position control with at least three-axis motors, and can perform various operations with additional drive devices. Conventional robots such as SCARA (Selective Compliance Assembly Robot Arm) robots and Cartesian robots are driven by a dedicated PLC controller or a high-performance PC controller, and are controlled by storing a predetermined coordinate table in memory and driving according to the table. Such methods have difficulties in that the coordinate table must be modified each time an operation pattern changes, and are not suitable for an operation of filling a three-dimensional empty space. Therefore, a command code book related to operations of the delta robot may be introduced, and the delta robot may be implemented to receive only command codes transmitted by communication from the computing device 140. Accordingly, the robot may be controlled from many control devices such as computers, smartphones, and programming boards through wired and wireless connections such as a serial port, Bluetooth, and Wi-Fi.

Next, the robot 130 may start an operation of loading a cushioning material into the internal empty space region according to the command code (S470). While the robot 130 performs an operation of loading a cushioning material into the internal empty space region of the packaging box according to the command code, if a filling rate of the cushioning material filled into the internal empty space region is greater than or equal to a predetermined reference, the robot may terminate the cushioning material loading operation for the corresponding packaging box (S480).

Here, the filling rate may be calculated by the following equation.

$$filling rate ( \% ) = ( \frac{{V}_{F}}{{V}_{S}} ) \times 100 \qquad [ Equation 2 ]$$

V_{F} is a volume of cushioning material filled by the robot into the internal empty space region, and V_{S} corresponds to a volume of the internal empty space region of the packaging box before the cushioning material is filled. If the filling rate is set to 95%, the robot 130 terminates an operation of filling the cushioning material into the internal empty space region of the packaging box.

The embodiments described above may be implemented by hardware components, software components, and/or a combination of hardware components and software components. For example, the devices, methods, and components described in the embodiments may be implemented by using one or more general-purpose computing devices or special-purpose computing devices, such as a processor, a controller, an ALU (arithmetic logic unit), a digital signal processor, a microcomputer, an FPGA (field programmable gate array), a PLU (programmable logic unit), a microprocessor, or any other device capable of executing and responding to instructions. A processing device may execute an operating system (OS) and one or more software applications running on the operating system. In addition, the processing device may access, store, manipulate, process, and generate data in response to execution of software. For convenience of description, a processing device has been described as if one is used, but those skilled in the art will understand that the processing device may include a plurality of processing elements and/or a plurality of types of processing elements. For example, the processing device may include a plurality of processors or a processor and a controller. Other processing configurations, such as a parallel processor, are also possible.

Software may include a computer program, code, instructions, or a combination of one or more thereof, and may configure a processing device to operate as desired or command the processing device independently or collectively. Software and/or data may be embodied, permanently or temporarily, in any type of machine, component, physical device, virtual equipment, computer storage medium, or device, to be interpreted by a processing device or to provide instructions or data to the processing device. Software may also be distributed over computer systems connected through a network, and may be stored or executed in a distributed manner. Software and data may be stored in one or more computer-readable recording media.

A method according to an embodiment may be implemented in the form of program instructions executable through various computer means and recorded on a computer-readable medium. The computer-readable medium may include program instructions, data files, and data structures alone or in combination. Program instructions recorded on the medium may be specially designed and configured for the embodiments, or may be those publicly known and available to those skilled in computer software. Examples of the computer-readable recording medium include magnetic media such as a hard disk, a floppy disk, and magnetic tape; optical media such as CD-ROMs and DVDs; magneto-optical media such as a floptical disk; and hardware devices such as ROM, RAM, and flash memory that are specially configured to store and execute program instructions. Examples of program instructions include not only machine code generated by a compiler but also high-level language code that can be executed by a computer using an interpreter or the like. The above-described hardware devices may be configured to operate as one or more software modules to perform the operations of the embodiments, and vice versa.

Although the embodiments have been described above with reference to limited drawings, those skilled in the art will appreciate that various technical modifications and variations may be applied based on the foregoing description. For example, the described technologies may be performed in a different order than the described methods, and/or the components of the described systems, structures, devices, and circuits may be combined or integrated in a different form, or replaced or substituted with other components or equivalents, without departing from the scope of appropriate results.

1. A cushioning material filling and packaging automation system using a robot, comprising:
a three-dimensional scanner installed at a predetermined distance above a conveyor belt to three-dimensionally scan, in a downward direction from above a packaging box, an interior of the packaging box being conveyed on the conveyor belt in a state in which an upper surface of the packaging box is open;
a robot that performs an operation of loading a cushioning material into an internal empty space region of the packaging box excluding an object contained in the packaging box; and
a computing device that processes three-dimensional scanning data acquired from the three-dimensional scanner to detect the internal empty space region of the packaging box, calculates, for each combination of a cushioning material stacking direction, a type of cushioning material, and a cushioning material loading path pattern, a cushioning material loading path for loading the cushioning material into the internal empty space region, selects, among the combinations, a combination in which a difference between a volume of the cushioning material loaded according to the calculated cushioning material loading path and a volume of the internal empty space region is minimized, and generates a command code to operate the robot to load the cushioning material into the internal empty space region according to the cushioning material loading path of the selected combination,
wherein the computing device divides the internal empty space region into a plurality of individual stacking planes having a predetermined thickness in accordance with a cushioning material loading direction, and calculates a cushioning material stacking path for loading the cushioning material into each of the plurality of individual stacking planes according to the cushioning material loading path pattern.

2. The system according to claim 1, wherein the cushioning material stacking direction includes a third direction perpendicular to a plane formed by a first direction and a second direction,
wherein a direction in which variance of packaging box empty-space modeling data corresponding to the internal empty space region is greatest is the first direction, and a direction in which the variance of the packaging box empty-space modeling data is second greatest is the second direction.

3. The system according to claim 2, wherein the cushioning material stacking direction further includes at least one of a horizontal direction parallel to a bottom surface of the packaging box and a vertical direction perpendicular to the bottom surface of the packaging box.

4. The system according to claim 1, wherein the computing device terminates the cushioning material loading operation of the robot for the packaging box if, while the robot is performing the operation of loading the cushioning material into the internal empty space region according to the command code, a filling rate of the cushioning material filled into the internal empty space region is greater than or equal to a predetermined reference.

5. A cushioning material filling and packaging automation method using a robot, comprising:
three-dimensionally scanning, using a three-dimensional scanner installed at a predetermined distance above a conveyor belt, in a downward direction from above a packaging box, an interior of the packaging box being conveyed on the conveyor belt in a state in which an upper surface of the packaging box is open;
processing, by a computing device, three-dimensional scanning data acquired from the three-dimensional scanner to detect an internal empty space region of the packaging box excluding an object contained in the packaging box;
calculating, by the computing device, for each combination of a cushioning material stacking direction, a type of cushioning material, and a cushioning material loading path pattern, a cushioning material loading path for loading the cushioning material into the internal empty space region;
selecting, by the computing device, among the combinations, a combination in which a difference between a volume of the cushioning material loaded into the internal empty space region according to the calculated cushioning material loading path and a volume of the internal empty space region is minimized;
generating, by the computing device, a command code to operate a robot to load the cushioning material into the internal empty space region according to the cushioning material stacking direction, the type of cushioning material, and the cushioning material loading path of the selected combination; and
performing, by the robot, an operation of loading the cushioning material into the internal empty space region according to the command code,
wherein calculating the cushioning material loading path comprises dividing the internal empty space region into a plurality of individual stacking planes having a predetermined thickness in accordance with the cushioning material loading direction, and calculating a cushioning material stacking path for loading the cushioning material into each of the plurality of individual stacking planes according to the cushioning material loading path pattern.

6. The method according to claim 5, wherein the cushioning material stacking direction includes a third direction perpendicular to a plane formed by a first direction and a second direction, wherein a direction in which variance of packaging box empty-space modeling data corresponding to the internal empty space region is greatest is the first direction, and a direction in which the variance of the packaging box empty-space modeling data is second greatest is the second direction.

7. The method according to claim 6, wherein the cushioning material stacking direction further includes at least one of a horizontal direction parallel to a bottom surface of the packaging box and a vertical direction perpendicular to the bottom surface of the packaging box.

8. The method according to claim 5, further comprising terminating, by the computing device, the cushioning material loading operation of the robot for the packaging box if, while the robot is performing the operation of loading the cushioning material into the internal empty space region according to the command code, a filling rate of the cushioning material filled into the internal empty space region is greater than or equal to a predetermined reference.
